(19) United States
(12) Patent Application Publication
(10) Pub. No.: US 2004/0230486 A1
(43) Pub. Date: Nov. 18, 2004

(54) System and method for creating a dynamic and interactive simulated remote-locale atmosphere

(76) Inventor: Garrett M. Greenlee, Westerville, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/845,797

(22) Filed: May 14, 2004

Related U.S. Application Data
(60) Provisional application No. 60/470,671, filed on May 15, 2003.

(51) Int. Cl. G06F 17/60

(52) U.S. Cl. 705/15

(57) ABSTRACT

A system and method for creating a dynamic and participatory atmosphere at an establishment relating to a particular remote locale. A thematic configuration comprises décor and display objects like those associated with static thematic configurations of the remote locale. A dedicated communications link is established between the establishment and the remote locale, the link providing two-way visual and aural communication between the establishment and the remote locale such that people at both locations may interact with each other. The establishment preferably includes an open-air environment to simulate the setting of the remote locale. Environmental controls may be used to maintain a corresponding yet comfortable environment. In addition to sight, sounds and environmental factors being used to simulate a desired remote locale, location-specific scents may be dispersed to add to the illusion of being at the remote locale. Tactile sensations consistent with the remote locale may also be provided.

This application claims priority to U.S. provisional application No. 60/470,671, filed May 15, 2003, the contents of which are hereby incorporated by reference.

### FIELD

This invention relates to a system and method for creating a simulated atmosphere. In particular, this invention relates to a system and method for simulating the sights, sounds, tastes, feel and scents of a particular remote locale with a dynamic and interactive atmosphere.

### BACKGROUND

Many retail establishments utilize objects and decor to project a particular theme. For example, restaurants serving Mexican food typically have on display items associated with Mexico, such as Mexican flags, pottery, cacti, art and murals. In addition, the interior of the restaurant may have Mexican architecture and/or be painted with vivid colors. To complete the theme, Latin music may be heard throughout the restaurant. These and other effects, such as lighting, costuming and native wait staff are intended to make the customer feel as if he or she is actually in the region portrayed by the theme. The purpose of a thematic configuration is to transform a customer's purchase from a mere transaction to a memorable “experience.” If the customer has an enjoyable and memorable experience while patronizing the establishment, he or she is more likely to return. Such customers are also more likely to recommend the establishment to others.

A shortcoming of current thematic configurations is that, except for the audio element, a static atmosphere is created. In other words, the theme experienced by the customer is essentially unchanged unless the establishment undergoes remodeling or redecorating. As a result, the novelty of the theme decreases over time and, in some cases, becomes an unnoticed part of the background from the perspective of the customer. There is a need for a dynamic thematic atmosphere wherein the elements that create the atmosphere are varied on a regular basis.

Another shortcoming of current thematic configurations is that they are generally either passive or aggressive. The prior example of a Mexican restaurant is a typical passive thematic configuration wherein the theme is conveyed by the backdrop of the surroundings. In contrast, thematic configurations such as mystery dinner theatres may be considered aggressive in that they strongly encourage or even demand customer participation. There is a need for an active thematic configuration that provides the customer with the opportunity to individually interact with the thematic atmosphere to a greater or lesser extent, in accordance with customer preferences.

### SUMMARY

According to the present invention, a system and method for creating a dynamic and participatory atmosphere in a business establishment are disclosed. A thematic configuration includes architecture, décor and display objects for a desirable remote locale, such as a tropical locale. Food and drinks associated with the remote locale are made using authentic recipes and imported spices. In addition, a dedicated communications link is established between the establishment and the remote locale, the link providing two-way visual and aural communication between the establishment and the remote locale such that people at both locations may interact with each other. Visual aspects of the remote locale, received through the communications link, may be projected on a large screen for central viewing, or may be incorporated into a plurality of displays attached to (or built into) the walls of the establishment, thereby simulating being in the midst of the remote locale. Likewise, aural aspects of the remote locale, such as beach sounds, may be received at the establishment through the communications link and played through speakers distributed about the establishment. The establishment preferably includes an open-air environment such as a patio to simulate the setting of a remote locale. Environmental controls such as heating, air-conditioning and air circulation may be used separately or in combination to maintain a corresponding yet comfortable environment. In addition to sight, sounds and environmental factors being used to simulate a desired remote locale, location-specific scents, such as sea spray and suntan lotion, may be dispersed to add to the illusion of being at the remote locale. Tactile sensations can be utilized for physical representation of the tropics. In summary, a memorable experience is created by effectively engaging all five senses. As a further extension of the simulation, the establishment may arrange for customers to visit the remote locale, enabling those customers to interact with local customers by means of the dedicated communications link, thereby strengthening customer loyalty and creating travel demand to the remote locale.

An object of the present invention is a system for creating, at an establishment, a simulated remote-locale atmosphere. The system includes a backdrop consistent with the remote locale. At least one product and/or service consistent with products and services found at the remote locale are offered by the establishment. In addition, the establishment utilizes environmental controls that replicate the environment of the remote locale. A bidirectional communications link is used to provide at least one of aural and visual communications between the establishment and the remote locale. As a result, customers of the establishment are able to partake of the sensory aspects of the remote locale in a simulated environment.

Another object of the present invention is a method for creating, at an establishment, a simulated remote-locale atmosphere. The steps of the method include providing a backdrop consistent with the remote locale and providing a plurality of products and services consistent with those found at the remote locale. Further steps include controlling the environment of the establishment to replicate the environment of the remote locale and communicating at least one of aural and visual information between the establishment and the remote locale. As a result, customers of the establishment are able to partake of the sensory aspects of the remote locale in a simulated environment.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a diagram of a system and method of creating a dynamic and interactive simulated remote-locale atmosphere in accordance with an embodiment of the present invention; and

FIG. 2 is a block diagram of an environmental control system according to an embodiment of the present invention.

### DETAILED DESCRIPTION

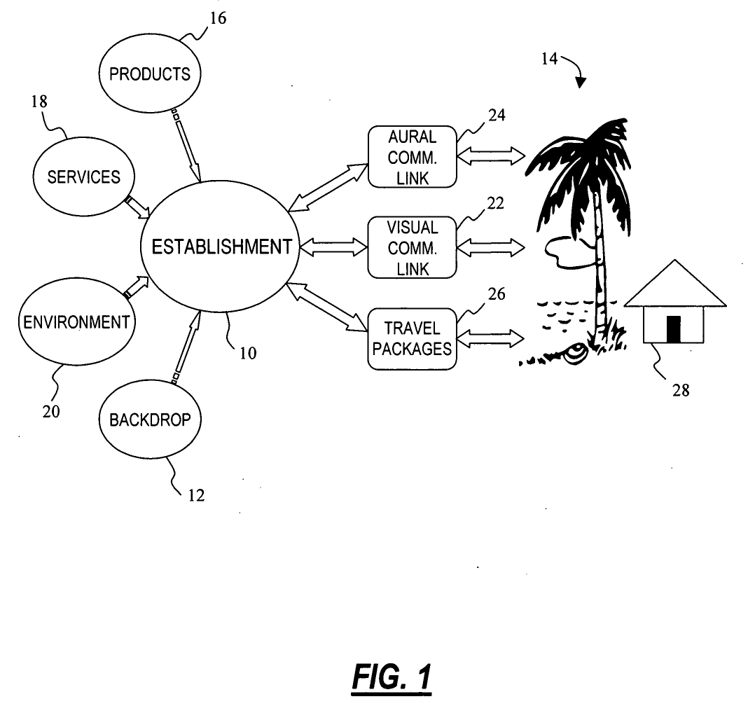

A system and method for creating a dynamic and active remote-locale atmosphere in an establishment are depicted in FIG. 1. By way of an example for the purpose of this disclosure an establishment 10 may be a restaurant simulating a particular remote tropical locale 14, although a wide variety of other remote locales and commercial settings are anticipated by this disclosure. The establishment 10 may utilize a plurality of components to create a tropical atmosphere.

A backdrop 12 forms a starting point for the simulated environment. Backdrop 12 comprises the architecture, décor, staff dress and furnishings consistent with a particular remote locale 14. As a relevant example the tropical locale selected may be a popular vacation or resort area such as Negril, Jamaica. However, any tropical location may be selected for remote locale 14, such as Honolulu, Maui, Havana and Cancun.

The products 16 and/or services 18 provided by the establishment may be consistent with those found in remote locale 14. Continuing the prior example of Negril, a restaurant according to an embodiment of the present invention may offer menu selections featuring “jerk chicken” and a wide variety of other traditional Jamaican dishes common to the remote locale 14. The flavors can be duplicated with authentic recipes and imported spices. Likewise, the food may be prepared and served in the same manner as is typical for remote locale 14, such as wrapping the jerk chicken in foil.

Creating a sensory environment 20 comparable to remote locale 14 is an essential component of the present invention. To replicate a tropical environment, for example, establishments located in non-tropical regions may employ various combinations of heating, air conditioning, shading, and air movement to create a tropical yet comfortable environment. It is considered important that the environmental control equipment be as inconspicuous as possible so as not to detract from the simulated atmosphere. Environment 20 preferably comprises an outdoor patio to provide an open-air setting. The patio may include a perimeter with a low wall topped by clear glass or LEXAN® panels. The perimeter serves to bound the environmentally controlled space of the patio while also serving as a windbreak. Ductwork installed into the low wall may be used to disperse conditioned air from disguised or hidden diffusers. In addition, the patio floor may have an embedded heating/cooling network to help condition a “living space,” generally defined herein as the air space from surface of the patio to a height of about six feet, within the boundary of the environmentally controlled space. Shading devices may optionally be employed to reduce heat loading of the living space during hot weather without detracting from the desired open-air setting. For example, a “spinnaker sail” in keeping with the tropical theme may be appropriately positioned to shade the living space from direct sunlight. The sail may be manually or automatically repositioned periodically as needed for optimum shading of the patio without a need to resort to individual umbrellas at the tables. It is important to note that the purpose of the environmental controls is not to heat or air-condition the living space so as to provide a contrasting warmth or coolness as compared to the outside temperature. Instead, the present invention creates a tropical temperature with an optional breeze. Thus, only as much heating or air conditioning as is required for a pleasant tropical temperature will be used to augment the ambient temperature. The optimum temperature for simulating a tropical setting is about 77° F. to 82° F. Thus, if the temperature is, for example, 50° F., heat may be added to the living area. An additional criteria of environment 20 is that the heating, air conditioning and air flow be accomplished in a way that the customers notice only the feel of a tropical setting. It is desirable that the source of heated or cooled air and air movers are not visible to the customers. This goal is achieved by the aforementioned heating/cooling network embedded in the patio and the hidden or disguised diffusers.

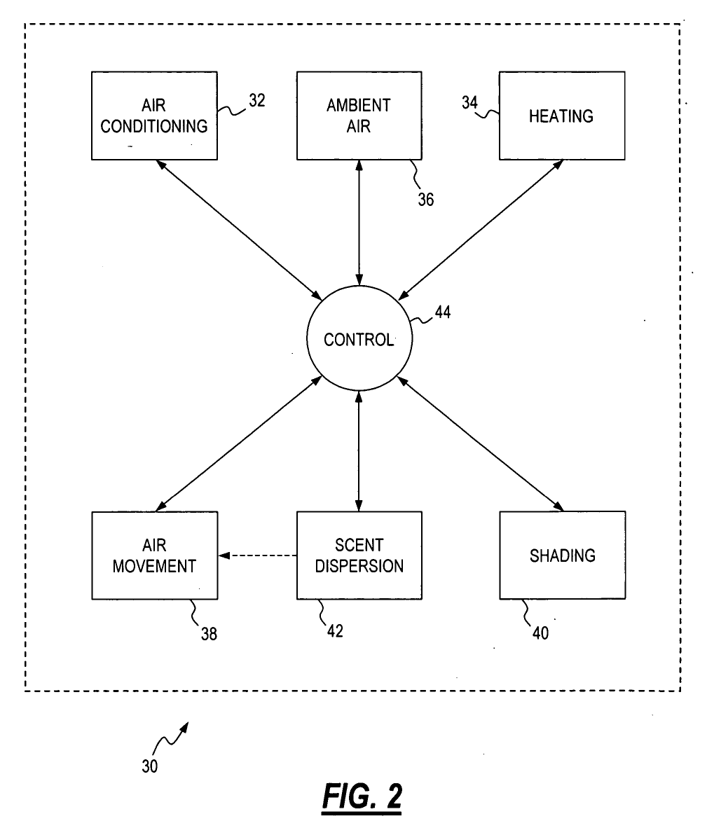

An example control system 30 to provide environment 20 according to an embodiment of the present invention is shown in FIG. 2. A conventional air conditioning subsystem 32 provides cooling air, while a conventional heating subsystem 34 provides warm air. Ambient air 36 may be mixed with the cool and warm air provided by air conditioning and heating subsystems 32, 34 respectively, in a ratio that provides the desired temperature of air used to augment the ambient atmosphere to simulate the environment of the remote locale, as discussed in detail above.

An air movement subsystem 38 provides air flow consistent with the remote locale, such as a tropical breeze. Air movement subsystem 38 may provide air at a consistent velocity, or may periodically or randomly vary the velocity of the air movement to simulate a natural breeze. Air movement subsystem 38 may operate independently, or may be interlinked with air conditioning and heating subsystems 32, 34 to distribute augmenting air.

A shading subsystem 40 monitors the position of a movable sun-shading element (not shown) in relation to a predetermined area, such as an outdoor patio. Shading subsystem 40 may be actuated by any conventional electromechanical means to re-position the sun-shading element as needed. In addition, re-positioning of the sun-shading element may be accomplished manually or automatically. Automatic repositioning may be by means of a conventional closed-loop control system that monitors for direct sunlight in the area to be shaded. Alternatively, the position of the sun shade may be calibrated to the positions of the sun in relation to the area to be shaded, such that the electromechanical actuation system adjusts the position of the shade at various times of day in accordance with a predetermined set of instructions, such as a computer program.

A scent dispersion subsystem 42 may be used in conjunction with other subsystems, such as air movement subsystem 38, to disperse scents consistent with the remote locale. Example scents include, without limitation, salt spray and suntan lotion. Scent dispersion is discussed in greater detail below.

A control portion 44 receives data from subsystems 32-42 relating to the current status of environmental variables controlled by each subsystem and makes adjustments to control values or settings of the subsystems in accordance with a predetermined set of instructions, such as a computer program, to match predetermined criteria consistent with the environment of the remote locale. Each subsystem 32-42 may be controlled individually to control individual environmental variables. Alternatively, some or all of subsystems 32-42 may be operated in conjunction with each other to achieve the desire simulation of the remote locale.

Although a single, central control 44 is shown in the embodiment of FIG. 2, one skilled in the art will appreciate that a plurality of controls may be used to control portions of system 30. Such controls may operate independently, or may be interlinked with some or all of the other controls to provide coordinated operation of subsystems 32-42.

With reference again to FIG. 1, a further component of the present invention is the use of bi-directional visual and aural links 22, 24. Links 22, 24 may comprise a at least one video camera, video display, microphone and speaker positioned at one or more key locations of the remote locale 14. Likewise, at least one video camera, video display, microphone and speaker are installed at the linked business establishment 10. Links 22, 24 will transmit live aural and visual information from remote locale 14 to establishment 10 in preferably near-real-time, providing customers of the establishment with varying live views of the remote locale 14. Links 22, 24 may also allow aural and visual information to be transmitted from establishment 10 to one or more locations at remote locale 14, such as a cooperative establishment 28 operating there. Any appropriate technology may be utilized to transmit and receive the aural and visual information, such as, but not limited to, “T1” lines, standard telephone lines, RF links, Internet links and satellite links. An example use of links 22, 24 would be transmitting visual images of sunsets and sounds of the surf from remote locale 14 to establishment 10. The sunset displayed in establishment 10 is preferably picturesque and will vary daily according to such factors as the weather conditions at remote locale 14. During inclement weather at remote locale 14 establishment 10 may, as an alternative to a live feed, choose to display previously-recorded scenes. Another example use of links 22, 24 would be to transmit to establishment 10 video and audio of customers visiting remote locale 14. Likewise, customers at establishment 10 may utilize the 22, 24 to communicate with friends who are visiting the remote locale. Links 22, 24 also provide a means to conduct commerce “on-line” such as to order merchandise or services from either end of the links. Further, links 22, 24 may be used to transmit to establishment 10 video and audio of live bands performing at the remote locale. Customers at establishment 10 may use links 22, 24 to request particular music or songs from the band.

A still further component of the present invention is the dispersion of scents to simulate the remote locale 14 (see FIG. 1). For example, a simulated tropical locale may be enhanced by scents such as salt spray and suntan lotion. Any convenient scent dispersers, such as sprayers, vaporizers, wicks and diffusers may be used. The scent dispersers may be manually and/or automatically operated, and may optionally be linked to the environmental control portion of the environment component 20.

An additional component of the present invention is the use of tactile means for a physical representation of remote locale 14. Example tactile means may include seating, tableware and flooring (such as sand or cobblestones) consistent with those customarily found at remote locale 14. For the example of a simulated tropical locale, sand bowls may be utilized.

Referring to FIG. 1, yet another component of the present invention is arranging travel packages 26 between establishment 10 and remote locale 14. Establishment 10 may make predetermined agreements with travel providers (not shown) to obtain attractive travel packages at a competitive price. Customers of establishment 10 may purchase travel packages 26 from the establishment or an approved third party travel provider and travel to remote locale 14. Once at remote locale 14, customers may utilize the visual and aural links 22, 24 to communicate with their friends and other customers at establishment 10. Optionally, establishment 10 and/or a cooperative establishment 28 at remote locale 14 may record the communications as a keepsake for the customers participating in the communications. After the customers return home, they will be able to recall fond memories of their trip to remote locale 14 by visiting establishment 10 and enjoying the atmosphere, thus fostering closer ties between the customers, establishment 10 and the remote locale, providing the establishment with repeat customers and aiding to increase the customer base of the establishment through word-of-mouth advertising. The entire process will aid to establish an emotional link between patron and establishment.

As can be seen from the foregoing discussion, the thematic configuration of establishment 10 is dynamic due to the constantly-changing aural and visual information transmitted from remote locale 14 to the establishment via links 22, 24. In addition, customers may interact with the thematic configuration to a greater or lesser extent as dictated by each customer's preferences. For example, a customer may choose to interact very little, deciding to merely enjoy the atmosphere. Other customers may elect to interact with remote locale 14 by utilizing links 22, 24. Still other customers may choose to visit remote locale 14. Finally, some customers may desire to interact with friends and customers at establishment 10 via links 22, 24 while visiting remote locale 14.

### EXAMPLE EMBODIMENT

Backdrop

The backdrop is a simulation of the tropical setting of Negril, Jamaica. Elements of the backdrop include, without limitation, an environmentally controlled patio, décor, furnishings, staff dress, and music reminiscent of Negril and Jamaica.

Environment

The establishment may include an outdoor bar and a large grill space. Stage set-up provisions may be included for live outdoor bands. An outdoor patio is environmentally controlled while maintaining an open-air design. The patio is available for comfortable outdoor seating between an ambient temperature range of about 20 to 95 degrees Fahrenheit. During the summer months, a movable sunshade in the shape of a spinnaker sail operates on rails. The sail automatically tracks the sun to provide shade while also adding interesting architectural detail to the space.

Products and Services

The present invention provides an entertainment and restaurant venue that markets an overall experience. The experience may include offerings of products and services as described below.

A restaurant/bar features moderately priced Caribbean cuisine in a unique atmosphere. The food and beverage offerings have a tropical flair with several authentic Jamaican flavors. There are also inexpensive, quickly prepared items such as Jamaican patties available for customers on a quick lunch break or eating before a game, concert or movie. At each visit to the establishment, customers will be exposed to a pleasing, simulated tropical environment that will encourage them to return.

A “happy hour” with discounted or special drinks and food is built towards as a daily special event. A live sunset may be broadcast from Negril, Jamaica, onto a large panoramic screen, creating a daily sunset celebration. A communications network is preferably utilized for high-quality video and audio feeds and to allow for additional simulcasts such as bands and beach parties.

A fresh juice bar incorporates the tropical theme providing flavorful concoctions that will compliment the meals. Types of beverages may range from a healthy breakfast blend to a high-end alcoholic drink offering.

The venue also provides live music, indoors and on the patio several nights per week, and after nearby sporting or entertainment events, such as concerts. The focus is preferably on Reggae-style music, but local bands with a complimentary format may also be featured. A house band may also be on staff.

Vacation packages may be offered at the establishment for travel to Negril. The trips will be available several times per year with attractive rates which include package discounts on airfare and hotels. Establishment staff will plan the vacation and accompany the group. Local Jamaican contacts and officials will be utilized to insure a smooth, carefree, one-of-a-kind memorable experience. The process of deciding to purchase a vacation package from an entertainment venue typically requires several visits to the establishment for the decision to be made to participate in a trip. This encourages return visits, further promotes the atmosphere of the establishment, and develops a core customer group.

Special services such as catering and private parties may also be offered. Such special services preferably continue the theme of the remote locale with such features as food, packaging, branding, logos and utensils being reminiscent of Negril and Jamaica

Technology Implementation

Interactive Video/Audio Feeds

A live sunset is broadcast from Negril, Jamaica every night of the week. A happy hour with food and beverage discounts and specials is scheduled around the showing. The sunset duration is typically about two hours long, providing a defining trait of the establishment and unique experience for customers. The sunset will be an event for which momentum will be built every day. At least one high-speed data network connection is preferably utilized for reliability and high-quality audio and video transmission and reception. Cameras are preferably placed in appropriate locations to capture the breathtaking sunsets from the Caribbean and send them directly to the establishment. The high quality feed will add a “reality-TV” feel to the venue, capitalizing on recent entertainment trends.

The live sunset image may be accomplished with multiple camera placements in Negril such as, for example, one camera located on the beach and another located on a cliff. A dedicated private line network, such as a conventional T1 line, may be utilized to provide a reliable, high-speed connection.

A bidirectional data connection is provided between the establishment and Negril, allowing simulcasting of beach parties. In addition, customers utilizing vacation specials offered by the establishment can interact with other customers in the establishment via the data connection while staying in Negril. Similarly, the vacationing customers may arrange for friends and relatives to visit the establishment and interact with them via the communications link. Thus, the vacation packages, in conjunction with the bidirectional data connection, act to draw additional customers to the establishment.

Patio

The patio simulates an open air, tropical setting. To extend availability of the patio in non-tropical climes, the patio is environmentally controlled. A low stone wall about three feet high encompasses the patio, establishing a perimeter. A glass or LEXAN® barrier raises the height of the wall to about six feet, effectively creating a boundary for the conditioned space and acting as a windbreak. Ductwork is placed inside the perimeter wall. Low-velocity, long-throw diffusers are located along the floor line to disperse conditioned air. This system utilizes a raised-floor HVAC design concept that conditions the space from the floor rather than from the ceiling, placing the emphasis on the “living space” which is typically about the first six feet from the floor.

In the summertime the temperature of air exiting from a packaged rooftop environmental control will be about 65 degrees Fahrenheit. The air will be able to travel along the floor without adversely cooling bare legs. The intent is to temper the extreme days, not to condition the temperature to interior-level expectations. Further, an innovative, architecturally interesting sunshade is employed as a temperature control. A triangle-shaped spinnaker sail from a sailboat is mounted via a three-point connection. The sail is placed on rails and raised above ground level. The sail is adapted to automatically move along a predetermined path, effectively tracking the sun to keep its rays from building up a heat load in the cement floor of the patio. This allows the patio to stay partially shaded while keeping an open setting, unencumbered by crowded shades such as umbrellas at every table.

In non-tropical climes cold weather often deters outside dining. To counter this the patio is heated. A concrete floor is poured with a conventional embedded glycol loop. A dedicated conventional boiler system is installed to create the hot water necessary for the loop. The heat from the cement will radiate, warming the space from the floor up. As the heat rises it will create a comfortable atmosphere. When the temperature drops below about 40 degrees, warm air will be dispersed from the diffusers along the perimeter wall to pick up heat from the cement and create a convective process.

The environmental control system will allow for a comfortable outdoor experience through an ambient temperature range of about 20 to 95 degrees Fahrenheit, extending the cumulative usable time of the patio from about two months out of the year for non-tropical climes to about ten months out of the year.

POS Wireless Technology

Wireless Point of Sale technology operates with a radio-frequency signal that transmits orders from the server at the table to the kitchen or bar, respectively. A server places an order at the table with a handheld device. Order-fulfillment staffs receive the order and deliver the food or beverages to the table. This allows a server to go from table to able, eliminating trips back and forth from the kitchen to get and deliver the order. They will instead be able to spend more time at the table interacting with customers, helping to create a casual, relaxed atmosphere, while simultaneously providing fast service. Table turns will increase without rushing customers out.

While this invention has been shown and described with respect to a detailed embodiment thereof, it will be understood by those skilled in the art that various changes in form and detail thereof may be made without departing from the scope of the claims of the invention.

What is claimed is:

1. A system for creating, at an establishment, an atmosphere simulating a remote locale, comprising:
a backdrop consistent with the remote locale;
at least one of products and services consistent with products and services found at the remote locale;
environmental controls that replicate the environment of the remote locale; and
a bidirectional communications link providing at least one of aural and visual communications between the establishment and the remote locale,
wherein customers of the establishment are able to partake of the sensory aspects of the remote locale in a simulated environment.

2. The system of claim 1, wherein the backdrop includes at least one of architecture, décor, staff dress, tactile means, and furnishings consistent with the architecture, décor, dress, tactile sensations and furnishings associated with the remote locale.

3. The system of claim 1, wherein the products and services include food and drinks prepared and served in a manner associated with the remote locale.

4. The system of claim 1, wherein the environmental controls include at least one of heating, air conditioning, shading, and air movement to provide environmental conditions associated with the remote locale.

5. The system of claim 4 wherein the environmental controls further include the dispersion of scents associated with the remote locale.

6. The system of claim 1 wherein the communications link includes at least one of:
at least one video camera;
at least one microphone;
at least one visual display; and
at least one audio speaker.

7. The system of claim 6 wherein the communications link is at least one of a T1 telephone line, a standard telephone line, a radio frequency link, an Internet link and a satellite link.

8. The system of claim 1, further comprising travel packages allowing customers of the establishment to visit the remote locale.

9. A system for creating, at an establishment, a simulated remote-locale atmosphere, comprising:
a backdrop including at least one of architecture, décor, staff dress, tactile means, and furnishings consistent with the architecture, décor, dress, tactile sensations and furnishings associated with the remote locale;
food and drinks prepared and served in a manner associated with the remote locale;
at least one of heating, air conditioning, shading, air movement and scent dispersion environmental controls that provide environmental conditions associated with the remote locale; and
a bidirectional communications link providing at least one of aural and visual communications between the establishment and the remote locale,
wherein customers of the establishment are able to partake of the sensory aspects of the remote locale in a simulated environment.

10. The system of claim 9, further comprising travel packages allowing customers of the establishment to visit the remote locale.

11. A method for creating, at an establishment, a simulated remote-locale atmosphere, comprising the steps of:
providing a backdrop consistent with the remote locale;
providing at least one of products and services consistent with the products and services found at the remote locale;
controlling the environment of the establishment to replicate the environment of the remote locale; and
communicating at least one of aural and visual information between the establishment and the remote locale,
wherein customers of the establishment are able to partake of the sensory aspects of the remote locale in a simulated environment.

12. The method of claim 9, wherein the backdrop includes at least one of architecture, décor, staff dress, tactile means, and furnishings consistent with the architecture, décor, dress, tactile sensations and furnishings associated with the remote locale.

13. The method of claim 9, wherein the products and services include food and drinks prepared and served in a manner associated with the remote locale.

14. The method of claim 9, wherein the environment is controlled by providing at least one of heating, air conditioning, shading, and air movement to provide environmental conditions associated with the remote locale.

15. The method of claim 14 wherein the environment is further controlled by dispersing scents associated with the remote locale.

16. The method of claim 9 wherein the communications are accomplished using at least one of:
at least one video camera;
at least one microphone;
at least one visual display; and
at least one audio speaker.

17. The system of claim 16 wherein the communications are accomplished using at least one of a T1 telephone line, a standard telephone line, a radio frequency link, an Internet link and a satellite link.

18. The method of claim 9, further comprising the step of providing travel packages allowing customers of the establishment to visit the remote locale.

19. A method for creating, at an establishment, a simulated remote-locale atmosphere, comprising the steps of:
providing a backdrop including at least one of architecture, décor, staff dress, tactile means, and furnishings consistent with the architecture, décor, dress, tactile sensations and furnishings associated with the remote locale;
providing at least one of products and services relating to food and drinks prepared and served in a manner associated with the remote locale;
controlling the environment of the establishment to replicate the environment of the remote locale by controlling at least one of heating, air conditioning, shading, air movement and scent dispersion; and
communicating at least one of aural and visual information between the establishment and the remote locale,
wherein customers of the establishment are able to partake of the sensory aspects of the remote locale in a simulated environment.

20. The method of claim 19, further comprising the step of providing travel packages allowing customers of the establishment to visit the remote locale.
